(19) United States
(12) Patent Application Publication
(10) Pub. No.: US 2012/0208580 A1
(43) Pub. Date: Aug. 16, 2012

(54) FORWARD ERROR CORRECTION SCHEDULING FOR AN IMPROVED RADIO LINK PROTOCOL

(75) Inventors: Michael G. Luby, Berkeley, CA (US); Mark Watson, San Francisco, CA (US); Ramin Rezaiifar, San Diego, CA (US); Lorenzo Vicisano, Berkeley, CA (US)

(73) Assignee: QUALCOMM INCORPORATED, San Diego, CA (US)

(21) Appl. No.: 13/025,934

(22) Filed: Feb. 11, 2011

(51) Int. Cl. H04W 72/12

(52) U.S. Cl. 455/509

(57) ABSTRACT

Forward error correction scheduling techniques for an improved radio link protocol used in a wireless communication system, such as EV-DO. In one embodiment scheduling of the generation of repair symbols encoded to be transmitted along with source data is described. In another embodiment acknowledgment messages from a receiver are used to control the trailing edge of the protection window offered by the repair symbols. In another embodiment, non-acknowledgment messages from a receiver are used to control the generation of extra repair symbols. In another embodiment, a length field is used to avoid transmission of padding bytes over the air. In yet another embodiment, a symbol auxiliary field is appended to source symbols to indicate the padding bytes needed for symbol aligning thus avoiding the transmission of padding bytes over the air.

### RELATED APPLICATIONS

The present Application for Patent is related to the following co-pending U.S. Patent Applications, each of which is filed concurrently herewith, assigned to the assignee hereof, and expressly incorporated by reference herein:

U.S. Patent Application entitled “Framing for an Improved Radio Link Protocol Including FEC” by Mark Watson, et al., having Attorney Docket No. 092888U1; and

U.S. Patent Application entitled “Encoding and Decoding Using Elastic Codes with Flexible Source Block Mapping” by Michael G. Luby, et al., having Attorney Docket No. 092840.

### TECHNICAL FIELD

The present disclosure relates to electronics and more particularly to forward error correction scheduling techniques for an improved Radio Link Protocol (RLP) used in the transport mechanism of data packets in wireless communication systems.

### BACKGROUND

Wireless communication systems are widely deployed to provide various communication services such as voice, video, packet data, messaging, broadcast, etc. These systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

Wireless communication networks are based on the OSI reference model and are organized as a series of layers with well-defined interfaces, and with each layer built on its predecessor. Each layer performs a related subset of functions and relies on the next lower layer to perform additional functions. Moreover, each layer offers certain services to the next higher layer. Individual layers on one system communicate with respective layers on another system in accordance with a set of rules and conventions constituting a layer protocol. Except from the physical layer, where a physical link exists between the transmitter side and the receiver side of the corresponding layers, all other layers are in virtual communication with their distant peers, forming logical links. These links, logical or physical, are characterized, among other things, by throughput and latency.

Throughput or network throughput is the average rate of successful data packet delivery over a communication channel. This data packet may be delivered over a physical or logical link, or pass through a certain network node. Throughput is usually measured in bits per second (bit/s or bps), and sometimes in data packets per second or data packets per time slot. Latency, on the other hand, is the time taken for a sent data packet to be received at the other end. It includes the time to encode the packet for transmission and transmit it, the time for that data to traverse the network equipment between the nodes, and the time to receive and decode the data.

Many wireless systems, such as the EV-DO system, use the Radio Link Protocol for network-based error corrections to ensure robust data transmission. RLP is designed to optimize the performance data flows for an upper layer, typically an application layer, crossing the wireless link, especially to maximize the utilization of the link. RLP uses packet retransmission to hide the errors at the physical or the MAC layers from the upper layers, presenting a very low error rate to the application layer. At the same time RLP strives to minimize the link end-to-end latency to keep the link throughput as close as the PHY throughput as possible. Both error rate and latency greatly affect TCP performance.

For the most part RLP achieves its goal effectively. There are conditions however where RLP doesn't perform optimally. For example in the presence of packet reordering, RLP tends to assume packet loss and hence trigger unnecessary retransmissions. Similarly, in the presence of high error rate, either at the MAC or the physical layer, the physical layer of a wireless wide area network (WWAN) link is characterized by a frame error rate higher than what typical data application can tolerate.

For example, WWAN supporting TCP/IP data packets cannot tolerate data packet loss without significant throughput degradation. WWAN technology usually addresses this issue with retransmission-based reliability schemes that hide most of the errors from TCP/IP. Such an example is RLP in EV-DO.

If a WWAN system is tuned to operate in a regime where the physical error rate is higher than the standard's settings (1%), the residual error rate presented to RLP would be such that multiple RLP retransmissions could be necessary to present an acceptable error rate at the upper (application) layer. This would significantly increase the latency of the WWAN performance.

Optimization of the operation of upper layer protocols (such as TCP) remains a goal of an improved RLP protocol. Any new RLP protocol should provide: (i) reduced sensitivity to packet reordering, (ii) larger physical error rate operating range, (iii) more consistent latency in the presence of packet loss and/or reordering, (iv) simpler design and (v) good response to burst losses caused, for example, by changing the Serving Sector (cell re-pointing).

### BRIEF DESCRIPTION OF THE DRAWINGS

FIG. 1 shows a network layer diagram of a wireless communication system.

FIG. 2 shows an example Radio Link Protocol (RLP) error correction technique using retransmissions.

FIG. 3 shows a sequence and scheduling diagram of source and repair symbols based on open-loop chord elastic codes, according to an exemplary embodiment.

FIG. 4A is a flow diagram of the encoding process of the exemplary embodiment of FIG. 3

FIG. 4B is a flow diagram of the decoding process of the exemplary embodiment of FIG. 3.

FIG. 4C is a block diagram of a transmitter packet application layer module of the exemplary embodiment of FIG. 3

FIG. 5 shows a sequence and scheduling diagram of source and repair symbols based on closed-loop chord elastic codes, according to another exemplary embodiment.

FIG. 6A is a flow diagram of a scheduling process of the exemplary embodiment of FIG. 5, based on ACK messages.

FIG. 6B is a flow diagram of a scheduling process of the exemplary embodiment of FIG. 5, based on NAK messages.

FIG. 6C is a block diagram of a transmitter PAL module and a receiver PAL module of the exemplary embodiment of FIG. 5.

FIG. 7 shows a Packet Application Layer PDU packet format according to an exemplary embodiment.

FIG. 8A shows a data flow diagram in accordance with an exemplary embodiment.

FIG. 8B shows an alternative symbol aligning process for the exemplary embodiment of FIG. 8A.

FIG. 9A is a flow diagram of packet transporting at a transmitter according to the exemplary embodiment of FIG. 8A.

FIG. 9B is a flow diagram of packet transporting at a receiver according to the exemplary embodiment of FIG. 8A.

FIG. 10A is a block diagram of a transmitter PAL module according to the exemplary embodiment of FIG. 8A.

FIG. 10B is a block diagram of a receiver PAL module according to the exemplary embodiment of FIG. 8A.

FIG. 11A is a flow diagram of packet transporting at a transmitter according to the exemplary embodiment of FIG. 8B.

FIG. 11B is a flow diagram of packet transporting at a receiver according to the exemplary embodiment of FIG. 8B.

FIG. 12A is a block diagram of a transmitter PAL module according to the exemplary embodiment of FIG. 8B.

FIG. 12B is a block diagram of a receiver PAL module according to the exemplary embodiment of FIG. 8B.

To facilitate understanding, identical reference numerals have been used where possible to designate identical elements that are common to the figures, except that suffixes may be added, where appropriate, to differentiate such elements. The images in the drawings are simplified for illustrative purposes and are not necessarily depicted to scale.

The appended drawings illustrate exemplary configurations of the disclosure and, as such, should not be considered as limiting the scope of the disclosure that may admit to other equally effective configurations. Correspondingly, it has been contemplated that features of some configurations may be beneficially incorporated in other configurations without further recitation.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The data transmission techniques described herein may be used for various wireless communication systems such as CDMA, TDMA, FDMA, OFDMA and SCFDMA systems. The terms “system” and “network” are often used interchangeably. A CDMA system may implement a radio technology such as cdma2000, Universal Terrestrial Radio Access (UTRA), etc. cdma2000 covers IS-2000, IS-95, and IS-856 standards. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Cdma 2000 and UMB are described in documents from an organization named “3rd Generation Partnership Project 2” (3GPP2).

For clarity, certain aspects of the techniques are described below for a <High Rate Packet Data (HRPD)> system that implements <IS-856>. HRPD is also referred to as Evolution-Data Optimized (EV-DO), Data Optimized (DO), High Data Rate (HDR), etc. The terms HRPD and EV-DO are often used interchangeably. Currently, HRPD Revisions (Revs.) 0, A, and B have been standardized, HRPD Revs. 0 and A are deployed, and HRPD Rev. C is under development. HRPD Revs. 0 and A cover single carrier HRPD (1× HRPD). HRPD Rev. B covers multi-carrier HRPD and is backward compatible with HRPD Revs. 0 and A. The techniques described herein may be incorporated in any <HRPD revision>

The terms transmitter and receiver used herein refer to the three nodes that the current implementation of the RLP operates: Base Station Controller (BSC), Base Transceiver Station (BTS) and Access Terminal (AT).

These nodes may also support multi-carrier radio link configurations, where multiple radio links are used in parallel to increase the data rate available to the AT. Different radio links are potentially supported either by the same BTS or by physically distinct BTSes. In these configurations, RLP operates assuming independent parallel links on the forward path. As such, it runs a separate flow control protocols on each link. The data packets carry both per-link and global sequence numbers. The former is used for timely packet loss detection, the latter for reassembly and delayed loss detection.

The Multi-carrier configuration is prone to MAC packet re-ordering, that can adversely affect RLP. It would be advantageous to provide techniques to minimize latency at the logical link of the PAL layer by reducing retransmissions. One way of improving the performance of the RLP protocol is by introducing Forward Error Correction (FEC) at the Packet Application Layer (PAL). To address this issue, an enhanced BTS-BSC flow control algorithm is used that aims at reducing the buffer size at the BTS and hence the potential for packet reordering.

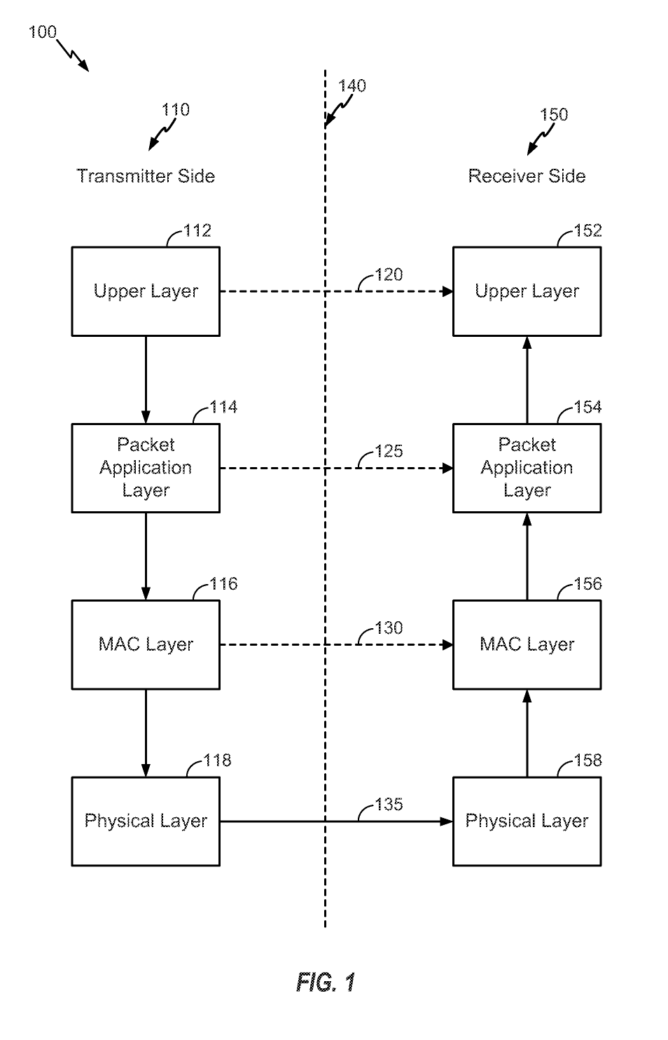

FIG. 1 shows a network layer diagram of wireless communication system. Wireless communication system 100 comprises of transmitter 110 and receiver 150 communicating over air channel 140. Transmitter 110 and receiver 150 are organized as a series of layers with well-defined interfaces, and with each layer built on its predecessor. Each layer performs a related subset of functions and relies on the next lower layer to perform additional functions. Moreover, each layer offers certain services to the next higher layer. Individual layers on one system communicate with respective layers on another system in accordance with a set of rules and conventions constituting a layer protocol. For the purposes of this disclosure only four layers are depicted. One skilled in the art can appreciate that a layer organized communication system may comprise more layers corresponding to the OSI reference model, or that more than one layers depicted may correspond to the same layer of the OSI model. In FIG. 1, transmitter 110 comprises upper layer 112, packet application layer 114, MAC layer 116 and physical layer 118. Receiver 150 comprises, respectively, upper layer 152, packet application layer 154, MAC layer 156 and physical layer 158. Each layer communicates with its peer through logical or physical links. Links 120, 125 and 130 are logical links and only link 135 is a physical link. In wireless communication systems the Radio Link Protocol is responsible for the Packet Application Layer.

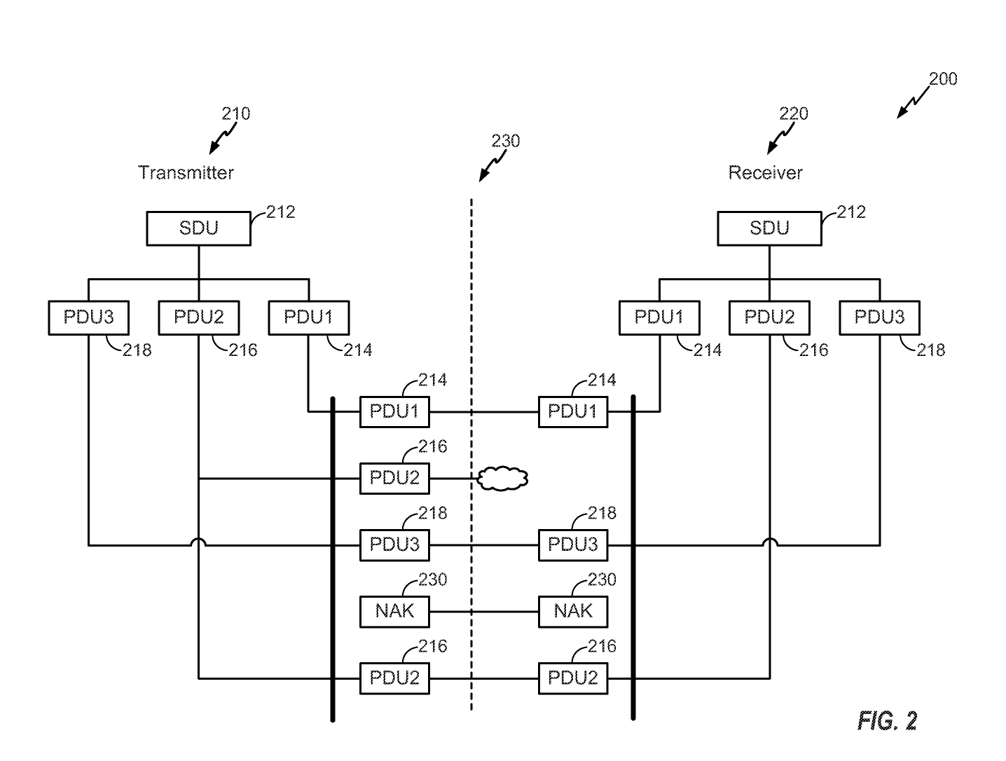

FIG. 2 shows an example Radio Link Protocol (RLP) error correction technique using retransmissions. In a typical implementation of the RLP, such as in EV-DO, error correction is handled with retransmission of data once a non-acknowledged (NAK) status message is received from the receiver. Referring to FIG. 2, Transmitter 210 segments upper layer packet SDU 212 into RLP PDUs 214, 216 and 218. Then, transmitter 210 transmits the RLP PDUs to receiver 220. When at least one of the RLP PDUs (in the example PDU2 216) is either lost or received damaged, receiver 220 sends a non-acknowledgment status message 230, requesting retransmission. Transmitter 210, in response, retransmits the lost RLP PDU2 216.

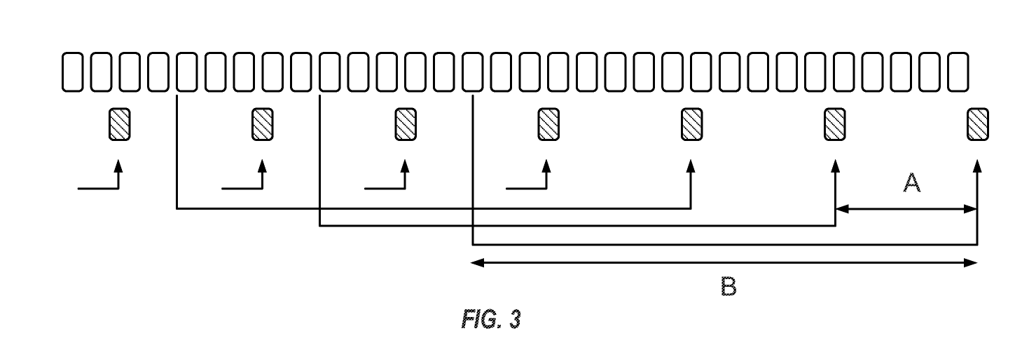

FIG. 3 shows a sequence and scheduling diagram of source and repair symbols based on open-loop chord elastic codes, according to an exemplary embodiment. An elastic code is an erasure code in which each repair symbol may be dependent on an arbitrary subset of the source symbols. A chord code is an elastic code in which the source symbols are arranged in a sequence forming a stream of source symbols and each encoding symbol (or repair symbol) is dependent on a set of consecutive source symbols.

Referring to FIG. 3, the upper sequence of symbols consists of source symbols that the transmitter produces by mapping incoming data into symbols. The lower sequence consists of repair symbols generated by the transmitter and are logically transmitted to the receiver along with the source symbols. The newest (most recent) symbols are on the right of the sequence. It should be noted that the sequence shown in FIG. 3 is a Packet Application Layer (PAL) sequence. That means that the symbols (source and repair) are generated in the PAL of the transmitter and reconstructed in the PAL of the receiver. This does not mean that the actual data bits contained in the source symbols has been physically transmitted through the physical layer. The symbols (source and repair) follow a logical link from the PAL of the transmitter to the PAL of the receiver.

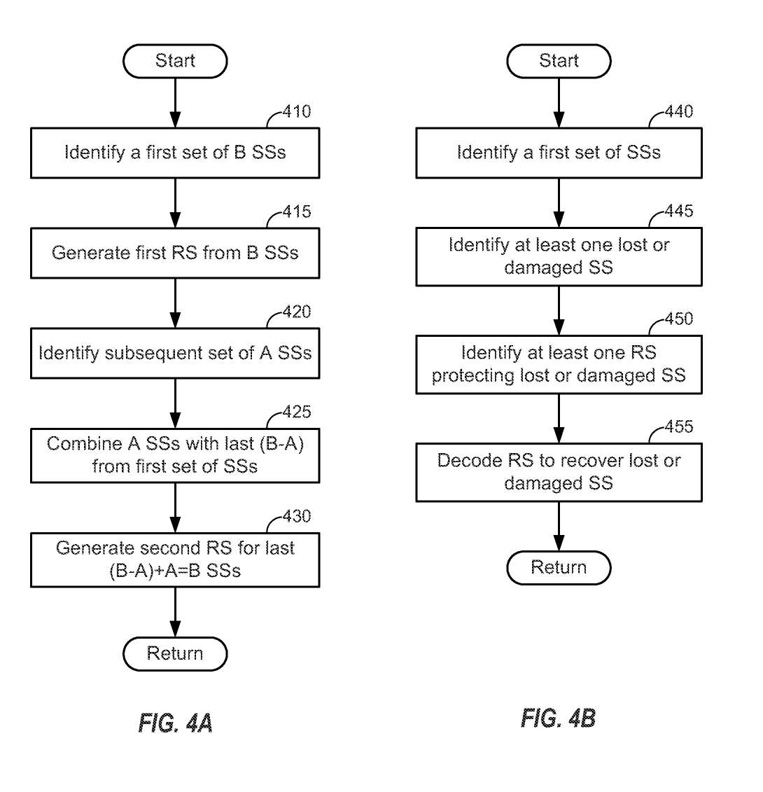

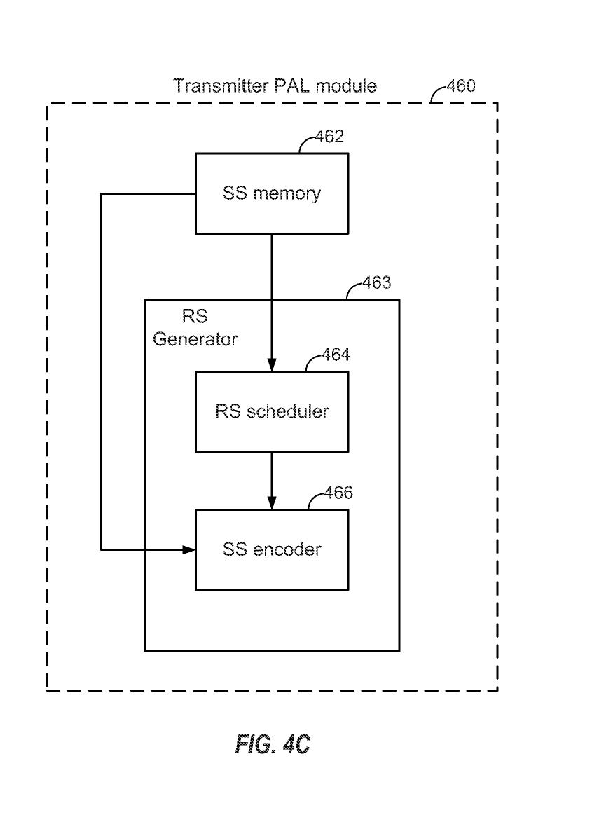

FIG. 4A is a flow diagram of the encoding process of the exemplary embodiment of FIG. 3. In a first step 410, the transmitter's PAL module identifies a first set of source symbols of number B in a stream of source symbols (SS). In step 415, the transmitter generates a first repair symbol by encoding the B number of source symbols identified in step 410. Then, the transmitter identifies a subsequent A number of source symbols in step 420 from the same stream of SSs. In step 425, the encoder combines the A number of SSs with the last (B-A) number of SSs at the end of the first set of the SSs identified in step 410, to create an overlapping set of source symbols of number B. In step 430, the transmitter generates a second repair symbol by encoding the overlapping set of SSs of number B.

A number of factors affect the determination of A and B including: (i) the target residual loss rate (Lt), (ii) the expected loss rate at the physical or the MAC layer (Lp), (iii) the average recovery latency that the receiver is willing to introduce in the stream (Davg) and (iv) the maximum recovery latency that the receiver is willing to introduce in the stream (Dmax). In the case of non-bandwidth-adaptive applications, the amount of bandwidth allowable for carrying repair symbols need also to be taken into account when selecting a value for A.

FIG. 4B is a flow diagram of the decoding process of the exemplary embodiment of FIG. 3. In step 440, the receiver's PAL module identifies a set of SSs and a set of RSs. Then, in step 445, the receiver's PAL module identifies at least one lost or damaged SS. Next, in step 450, the receiver identifies at least one RS protecting a portion of the set of SSs where the portion of the set of SSs includes the lost or damaged SS. Finally, in step 455, the receiver's PAL module decodes the RS to restore the lost or damaged SS.

FIG. 4C is a block diagram of a transmitter packet application layer module of the exemplary embodiment of FIG. 3. Transmitter PAL module 460 comprises of SS memory 462 and RS generator 463. RS generator 463 comprises RS scheduler 464 and SS encoder 466. SS memory 462 stores SSs from a stream of SSs. RS generator 663 identifies SSs according to the method described above with reference to FIG. 4A. RS scheduler 464 identifies a first set of SSs of number B. RS scheduler 464 counts the B number of SSs from the first set and instructs SS encoder 466 to generate an RS from the first set of SSs. Then RS generator 463 identifies a subsequent second set of A SSs. RS scheduler 464 identifies the subsequent A number of SSs. RS generator 463 combines the A number of SSs of the second set and the last (B-A) number of SSs from the first set of SSs to create an overlapping set of SSs of number B. Then SS encoder 466 encodes the overlapping set of SSs to generate a second RS.

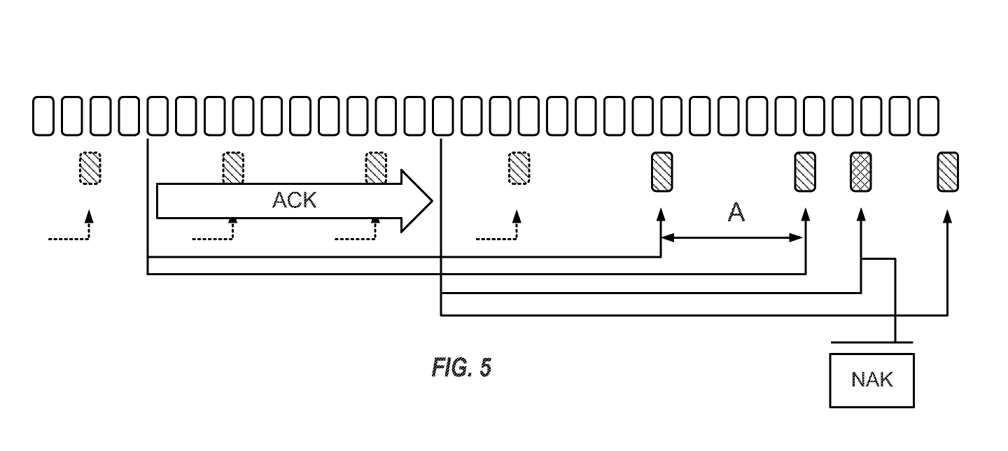

FIG. 5 shows a sequence and scheduling diagram of source and repair symbols based on closed-loop chord elastic codes, according to another exemplary embodiment. The upper sequence is a sequence of source symbols that the transmitter produces by mapping incoming source data into source symbols. The lower sequence is a sequence of repair symbols computed by the transmitter and transmitted to the receiver along with the source symbols. In the open-loop case, no feedback from the receiver was used. In the case of closed-loop chord elastic codes feedback from the receiver, in the form of acknowledgement messages (ACKs) and/or non acknowledgement messages (NAKs), is used to control the trailing edge of the protection window and to schedule the amount of RSs produced, respectively. More particularly, the receiver sends an ACK message to acknowledge the last SS received. The transmitter, then, moves the edge of the protection window up to the last acknowledged SS. The next RS generated, will provide protection back to the next SS after the last acknowledged one. Additionally, extra RSs are produced right after a NAK message has been received. The extra RS provides protection back from the SS that has been non-acknowledged from the receiver with the NAK message until the latest SS identified.

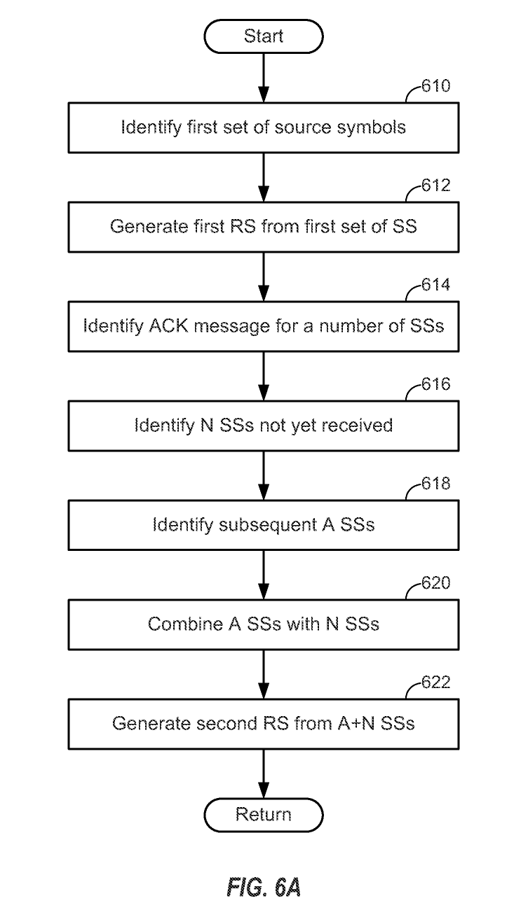

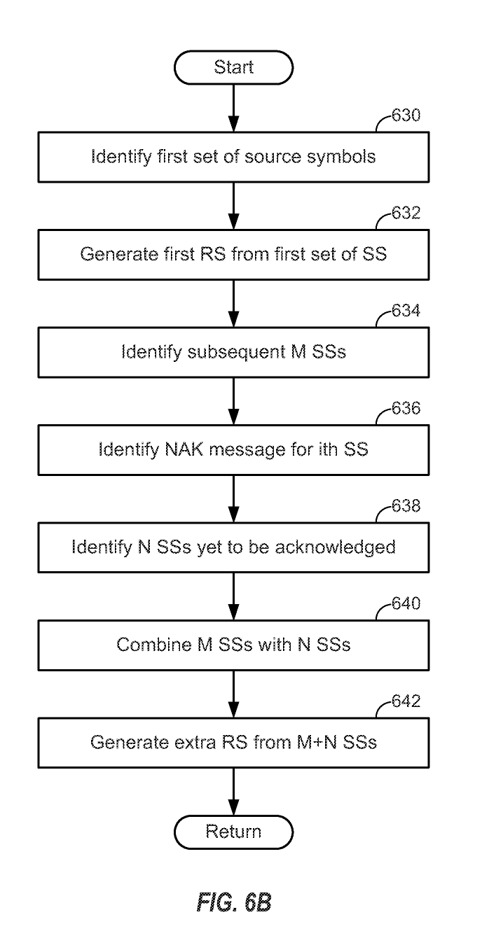

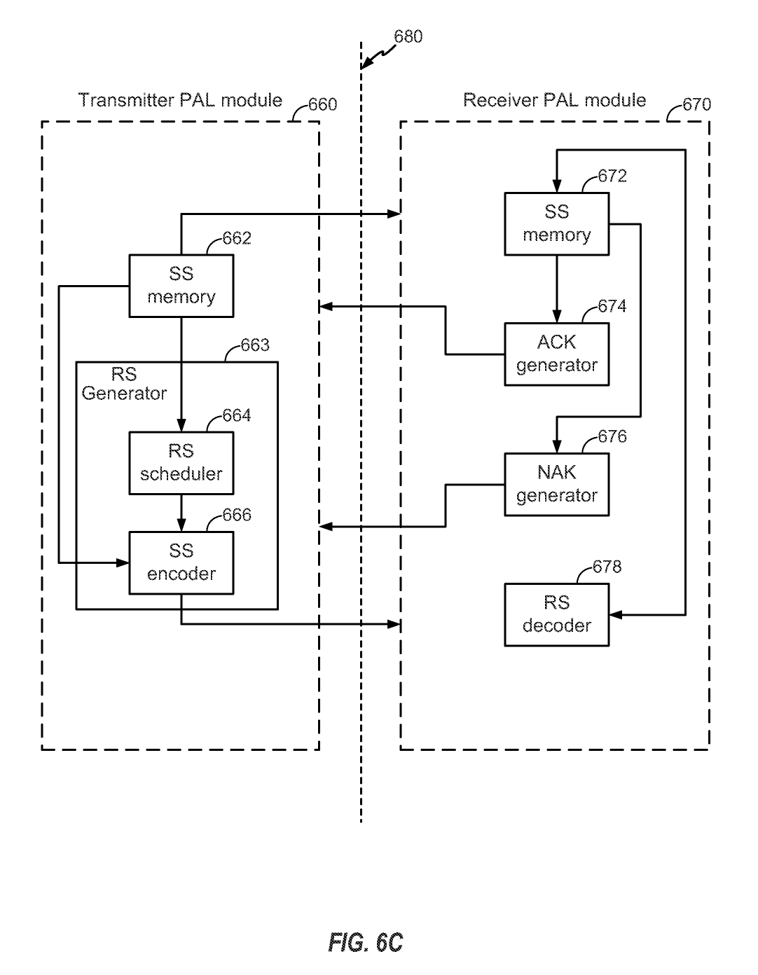

FIG. 6A is a flow diagram of a scheduling process of the exemplary embodiment of FIG. 5, based on ACK messages. In a first step 610, the transmitter's PAL module identifies a first set of B number of source symbols in a stream of SSs. In step 612, the transmitter's PAL module generates a first repair symbol by encoding the B number of source symbols of the first set of source symbols. Then, in step 614, the transmitter's PAL module identifies an acknowledgment (ACK) message sent from the receiver's PAL module, acknowledging receipt for X SSs. In step 616, the transmitter's PAL module identifies N number of source symbols not yet acknowledged from the first set of source symbols. In step 618, the transmitter's PAL module identifies a subsequent A number of SSs since the first RS was generated. In step 620, the transmitter's PAL module combines the A number of SSs with the N number of SSs to create an overlapping sequence of SSs. Finally, in step 622, the transmitter's PAL module generates a second RS from the overlapping sequence of SSs. The process repeats every time an ACK is received and subsequent SSs of number A are identified. Practically, the ACKs from the receiver's PAL module are used to advance the trailing edge of the protection window.

FIG. 6B is a flow diagram of a scheduling process of the exemplary embodiment of FIG. 5, based on NAK messages. In a first step 630, the transmitter's PAL module identifies a first set of B number of source symbols in a stream of SSs. In step 632, the transmitter's PAL module generates a first repair symbol by encoding the B number of source symbols of the first set of source symbols. In step 634, the transmitter's PAL module identifies a second set of SSs subsequent to the first set of M number of SSs. In step 636, the transmitter's PAL module identifies a non-acknowledgment (NAK) message received from the receiver's PAL module for a particular SS from the first set of SSs. Then, in step 638, the transmitter's PAL module identifies an N number of SSs from the first set of SSs that are yet to be acknowledged. Then, in step 640, the transmitter's PAL module combines the M number of SSs of the second set with the N number of SSs from the first set, to create an overlapping set of SSs. Finally, in step 642, the transmitter's PAL module generates an extra RS from the overlapping set of SSs. The NAKs are used to control the amount of RSs sent.

An alternative choice would be to retransmit the missing source symbol in response to a NAK instead of sending an extra RS. Sending an extra RS however is likely to be more efficient as the retransmitted SS might not be useful after all, either because an existing RS already recovered it or because it was never missing in the first place (NAK indication is not always 100% reliable). The extra RS has some likelihood of being useful even if not for repairing the SS that triggered it.

FIG. 6C is a block diagram of a transmitter PAL module and a receiver PAL module of the exemplary embodiment of FIG. 5. Transceiver comprises of transmitter PAL module 660 and receiver PAL module 670. Transmitter PAL module 670 comprises of SS memory 662 and RS generator 663. RS generator 663 comprises RS scheduler 664 and SS encoder 666. Receiver PAL module 670 comprises SS memory 672, ACK generator 674, NAK generator 676 and RS decoder 678. SS memory 662 stores SSs from a stream of SSs. RS generator 663 identifies SSs according to the method described above with reference to FIG. 6A. RS scheduler 664 identifies a first set of SSs of number B. RS scheduler 664 counts the B number of SSs from the first set and instructs SS encoder 666 to generate an RS from the first set of SSs. Then RS generator 663 identifies a subsequent second set of A SSs. The SSs are sent to receiver PAL module and are stored in SS memory 672. ACK generator 674 identifies the last SS received correctly in SS memory 672 and sends an ACK message acknowledging receipt up to a particular SS leaving N number of SSs out of the first set yet to be acknowledged. RS scheduler 664 identifies the subsequent A number of SSs. RS generator 663 first combines the A number of SSs of the second set and the N number of SSs from the first set of SSs to create an overlapping set of SSs of number N+A. Then SS encoder 666 encodes the overlapping set of SSs to generate the second RS. Additionally, based on feedback messages from NAK generator 676, RS generator 663 computes extra (unscheduled) RSs by encoding N+M number of SSs, where M is the number of SSs identified after the last RS was generated until the NAK message was received. The RSs from the RS generator 663 are transmitted over the, typically wireless, channel 680 and are decoded by RS decoder 678 to recover lost or missing SSs. The received or recovered SSs are stored in SS memory 678.

Both the open-looped and the closed-loop designs of repair symbol generation using chord elastic codes improves latency and latency variation in wireless communication systems over existing RLP protocol implementations such as EV-DO RLP protocols. However, introducing FEC at the PAL layer affects throughput because padding bytes are used for symbol aligning. Further optimization of the PAL throughput can be achieved if the padding octets used to symbol align source data, arriving to the PAL from an upper layer, to source symbols is not sent over the air. This can be achieved by appending indicators of the upper layer packet boundaries, instead of the actual padding, to the source or to the repair data.

At the PAL layer, messages larger than a specified size are subdivided prior to encoding and transmission into data packets not exceeding a specified size. In certain networks, these data packets are then mapped, for encoding purposes, to symbols of known length prior to transmission, according to predetermined Forward Error Correction (FEC) rules. An example is the protocol for streaming delivery in Multimedia Broadcast/Multicast Service (MBMS) described in 3GPP TS 26.346 V6.0.0 (2005-03), incorporated herein by reference.

In MBMS, a source block is created for mapping the source data to source symbols. The FEC source block shall contain at least one complete source packet, and a length field of two octets indicating the length of the source packet. Source packets in the source block are symbol aligned for efficiency purposes. To symbol align the source packet data, the information for each source packet placed into the source block is required to have a length that is an integer multiple of symbol length. If the length of the source packet plus the length of the length field does not comply with this requirement, padding bits, in octets of 0's, are added, typically, so that the overall length of the information for the source packet placed into the source block, defined by a Length Field (LF), the original source packet, plus potential padding, becomes an integer multiple of symbol length.

Radio Link Protocol currently provides retransmission and duplicate detection for an octet aligned data stream or a stream of packets. The RLP encapsulates these upper layer data packets (ULP) into packet application layer frames. The frames include the upper layer payload, which is at least a portion of the actual ULP data plus ULP framing information. The RLP separates the ULPs by adding a header that includes flags, or by including unique bit sequences that indicate the beginning and end of a frame within the source octet stream.

Typically, the resulting frame comprises flags and ULP data and is delivered to the next lower layer, which is the MAC layer. Eventually, through the MAC layer, the packet is delivered to the physical layer and is transmitted to the receiver.

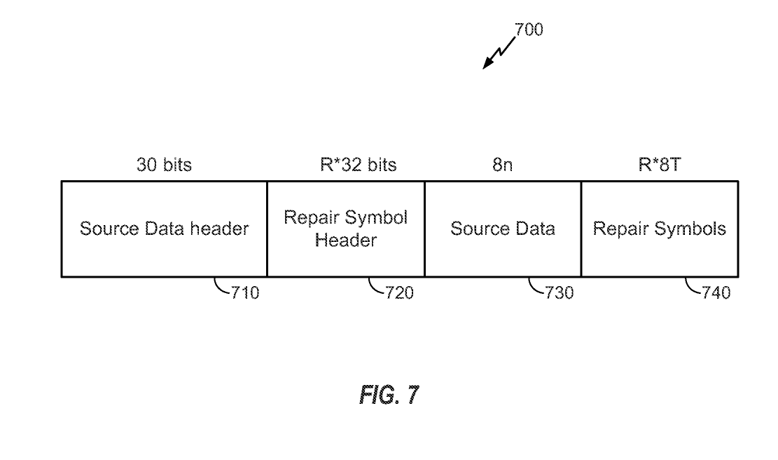

FIG. 7 shows a Packet Application Layer PDU packet format according to an exemplary embodiment. PAL PDU 700 comprises source data header 710, repair symbol header 720, source data octets 730 and repair symbols 740. Source data header 710 comprises 30 bits and RS header 720 comprises 32 bits for each RS.

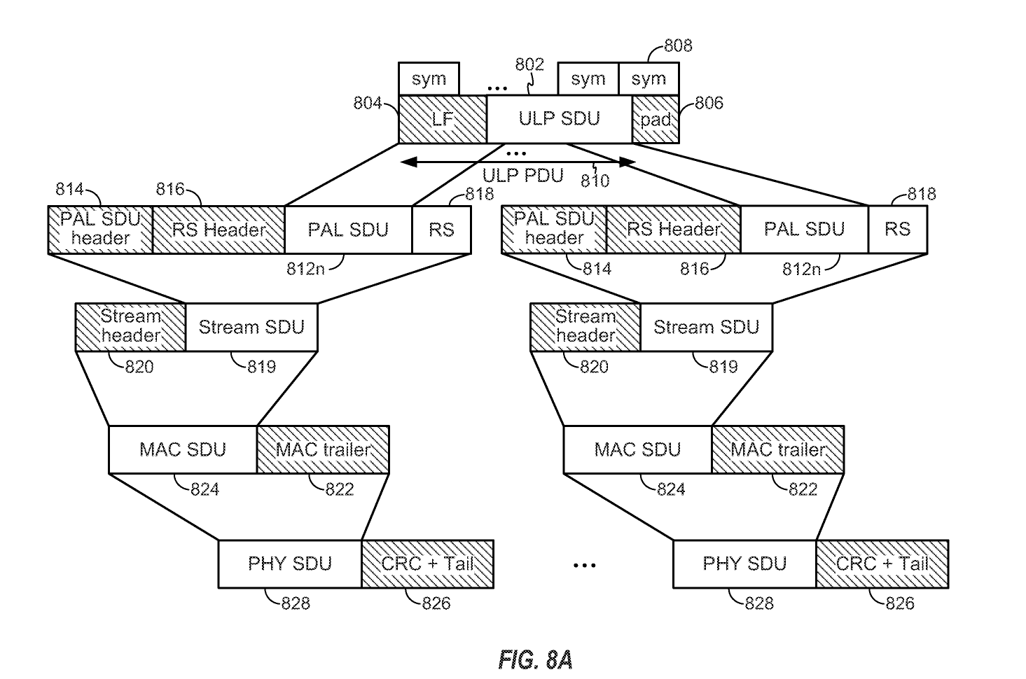

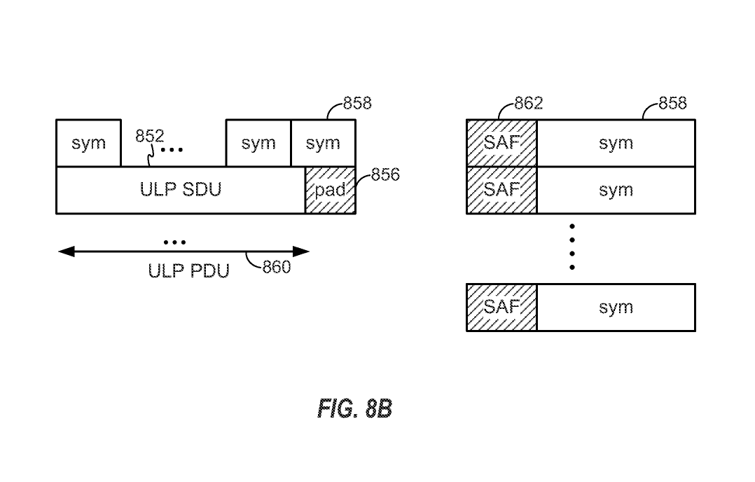

FIG. 8A shows a data flow diagram in accordance with an exemplary embodiment. Typically the data entity from/to a higher protocol layer is known as Service Data Unit (SDU) and the corresponding entity from/to a lower protocol layer entity is denoted Protocol Data Unit (PDU). Referring now to FIG. 8, ULP SDU 802 arrives from an upper layer (typically an application layer). Length Field (LF) 804 is added to ULP SDU 802 to create ULP PDU 810 where the length field is an indication of the boundaries of the ULP SDU. Then padding 806, typically in the form of octets, is appended to create a packet symbol aligned with symbols 808 for encoding purposes as described earlier. Symbol 808 has a length of T bits. ULP PDU 810, including only LF 804 and ULP SDU 802, is then segmented into several PAL SDUs 812(i . . . n), so that, whenever possible, each PAL SDU 812 is placed in one physical packet. It should be noted that ULP PDU 810 includes no padding. Subsequently, RSs are generated based on chord elastic encoding scheduling described earlier and are encapsulated in the same PAL packets with corresponding PAL SDUs 812(i . . . n). Appropriate framing and flow headers, such as PAL headers 816 and RS headers 814, are included in the encapsulation and the PAL PDUs are formed. PAL PDUs are formatted according to the PAL PDU packet format shown in FIG. 7. Each RS shall be encapsulated in a PAL PDU subsequent to the PAL PDU containing the last source octet protected by the RS. However, if insufficient source data is available to fill a PAL PDU, and one or more repair symbols could be included in the same Packet Application Layer packet without reducing the amount of source data in that packet, then a repair symbol may be encapsulated in the same PAL PDU as the last source octet it protects. In case the mode of operation is stream mode each PAL PDU is delivered as Stream SDU 819 where stream header 820 is added to form a stream PDU. The stream PDU is delivered to the MAC layer as MAC SDU 824. In case the mode of operation is packet mode the stream sub-layer is skipped and the PAL PDU is delivered to the MAC layer as MAC SDU. MAC trailer 822 is added to MAC SDU 824 to form a MAC PDU. The MAC PDU is delivered to the physical layer as PHY SDU 828 where Cyclic Redundancy Check (CRC) and tail trailer 826 are added to form the PHY PDU that will be transmitted across the physical layer to the receiver.

FIG. 8B shows an alternative symbol aligning process for the exemplary embodiment of FIG. 8A. Padding 856 is appended to ULP SDU 852 (without a length field) for symbol aligning with symbols 858. Symbol 858 has a length of T bits. ULP PDU 860, now, comprises only of ULP SDU 852. Now, instead of adding a LF to a ULP SDU for indicating the boundaries of a ULP PDU, Symbol Auxiliary Field (SAF) 862 of n bits is appended to each symbol 858. This field comprises a one bit “Start” indicator and an n-1 bit “PadPlusOne” indicator. For each SS, the “Start” bit of the Symbol Auxiliary Field is set to one if and only if the source symbol contains the beginning of a ULP SDU. The “PadPlusOne” bit contains the number of padding octets at the end of the SS, or zero if the SS does not contain the end of a ULP PDU.

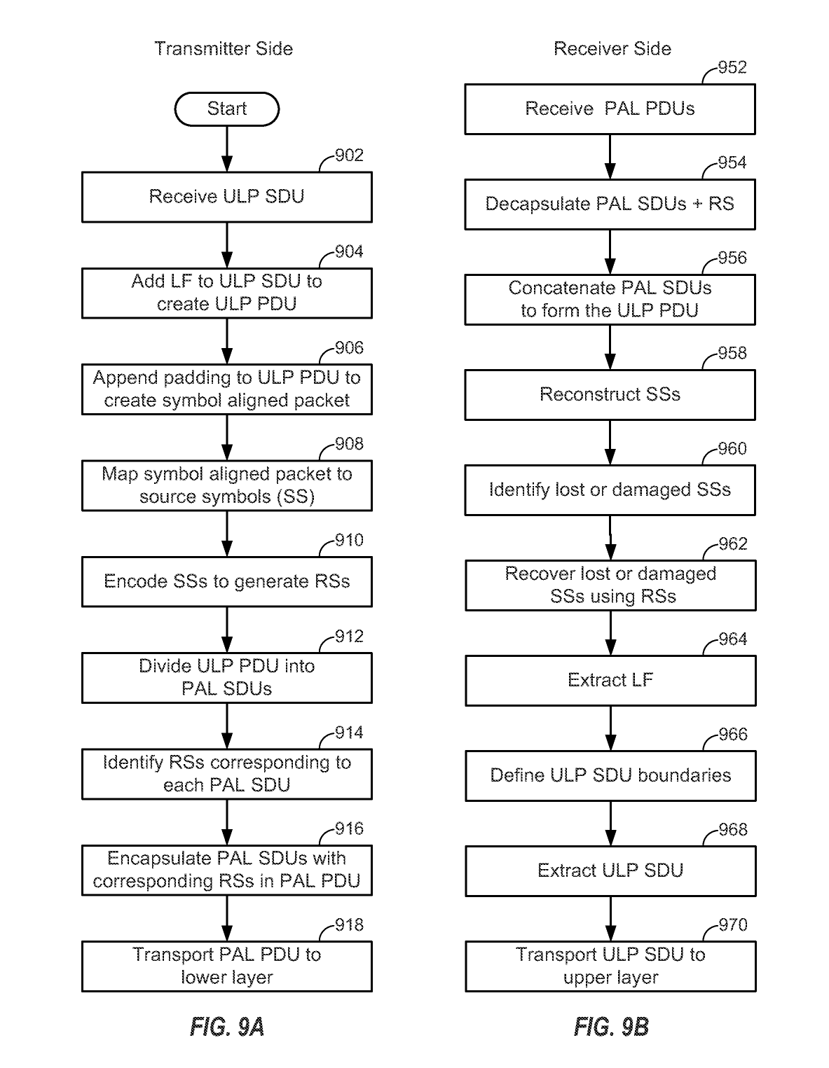

FIG. 9A is a flow diagram of framing a packet for transporting to a lower layer at a transmitter according to the exemplary embodiment of FIG. 8A. In step 902, the transmitter PAL module receives a ULP SDU. Then, in step 904, a LF of two bytes is added to the ULP SDU to create a ULP PDU, where the LF is the length of the ULP SDU in octets. Then appropriate padding in the form of octets is added, in step 906, to create a symbol aligned packet. That means that the total length of the LF, the ULP PDU and the padding is an integer multiple of symbol length. Then, in step 908, the symbol aligned packet, containing the LF, the ULP SDU and the padding, is mapped to source symbols. In step 910, the SSs are encoded to generate repair symbols according to chord elastic encoding described earlier in this application. Then, in step 912, the ULP PDU, without any padding, is segmented into PAL SDUs. Next, in step 916, the PAL SDUs are encapsulated with corresponding RSs to form PAL PDUs. Corresponding RSs comprise RSs generated to protect the SSs that were included in the previous PAL SDU, as described earlier with reference to FIG. 8. Finally, in step 918 the PAL PDU is delivered to a lower layer and is eventually transmitted.

FIG. 9B is a flow diagram of packet transporting at a receiver according to the exemplary embodiment of FIG. 8A. On the receiver side, in step 952, the receiver's PAL module receives the PAL PDUs. In step 952, the PAL SDUs and the corresponding RSs are decapsulated. Then, in step 956, the APL SDUs are concatenated to form the ULP PDU. In step 958, the SSs are reconstructed. Then, in step 960 the lost or damaged SSs are identified. Using the RSs, the lost or damaged SSs are recovered in step 962. Then, the LF of the ULP PDU is extracted, in step 964, to identify the boundaries of the recovered ULP SDU, in step 966. In step 968, the ULP SDU is extracted. Finally, in step 970, the ULP SDU is delivered to the upper layer.

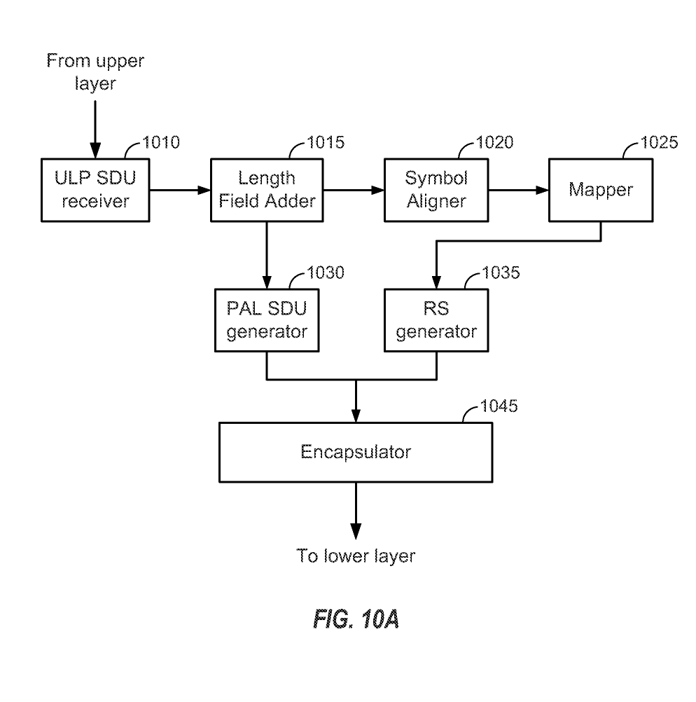

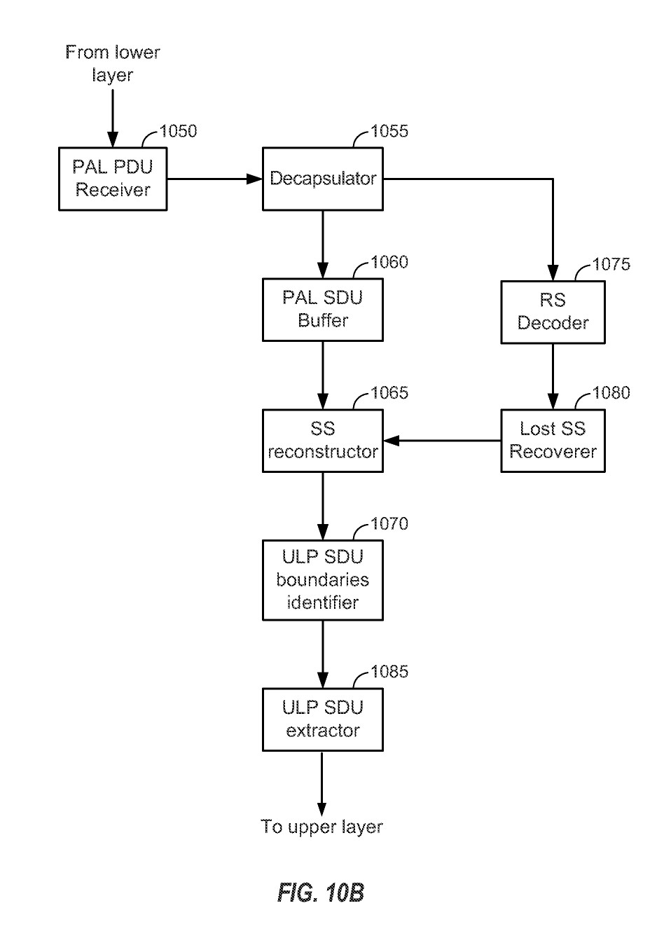

FIG. 10A is a block diagram of a transmitter PAL module according to the exemplary embodiment of FIG. 8A. Transmitter PAL module 1000 comprises ULP SDU receiver 1010 acting as an interface for receiving a ULP SDU from an upper layer. ULP SDU receiver 1010 forwards the ULP SDU to Length Field adder 1015, where a length field, corresponding to the length of the ULP SDU in octets, is appended to the ULP SDU to form a ULP PDU. LF adder 1015 forwards the ULP PDU comprising ULP SDU and the LF to symbol aligner 1020 and to PAL SDU generator 1030. Symbol aligner 1020 adds appropriate padding to the ULP PDU to form a symbol aligned packet. The length of the symbol aligned packet must be an integer multiple of one symbol length. Symbol aligner 1020 forwards the symbol aligned packet to Mapper 1025 where the symbol aligned packet is mapped to source symbols. The source symbols are then fed to RS generator 1035, where the repair symbols are generated from the source symbols they are going to protect based on chord elastic codes as described earlier. In parallel, PAL SDU generator 1030 receives the ULP PDU, comprising ULP SDU and LF (no padding included) and segments it to generate a plurality of PAL SDUs. In principle, the size of each PAL SDU must be such that only one PAL SDU is included in each physical layer packet. Each PAL SDU coming from PAL SDU generator 1030 and RS symbols coming from RS generator 1035, are fed to encapsulator 1045 where appropriate headers are added as described with reference to FIG. 7. Encapsulator 1045 produces PAL PDUs that are subsequently delivered to lower layers for further framing and processing. It is noted that the RSs encapsulated with a PAL SDU protect, generally, source symbols that were encapsulated in previous PAL PDUs. However, if insufficient source data is available to fill a PAL PDU, and one or more repair symbols could be included in the same PAL PDU without reducing the amount of source data in that packet, then a repair symbol may be included in the same PAL PDU with the last source data octet it protects.

FIG. 10B is a block diagram of a receiver PAL module according to the exemplary embodiment of FIG. 8A. PAL PDU receiver 1050 receives a PAL PDU from a lower level. Then, PAL Decapsulator 1055 decapsulates the PAL SDU and the corresponding RSs included in the PAL PDU. Each PAL SDU is fed to PAL SDU buffer 1060 where it stays until all PAL SDU's belonging to the same ULP PDU have been received. Then, PAL SDU buffer 1060 concatenates the PAL SDUs to form a provisional ULP SDU. The concatenated ULP SDU is fed to SS reconstructor 1065 where the SSs are reconstructed. In parallel, decoder 1075 receives RSs from Decapsulator 1055 and the reconstructed SSs. Decoder 1075 decodes the relevant RSs and feeds SS reconstructor 1065. The reconstructed or recovered SSs are fed to ULP SDU boundaries identifier 1070. There, the LF is identified and ULP SDU extractor 1085 is subsequently notified about the boundaries of the transmitted ULP SDU. ULP SDU extractor 1085, then, extracts the transmitted ULP SDU and delivers it to the upper layer.

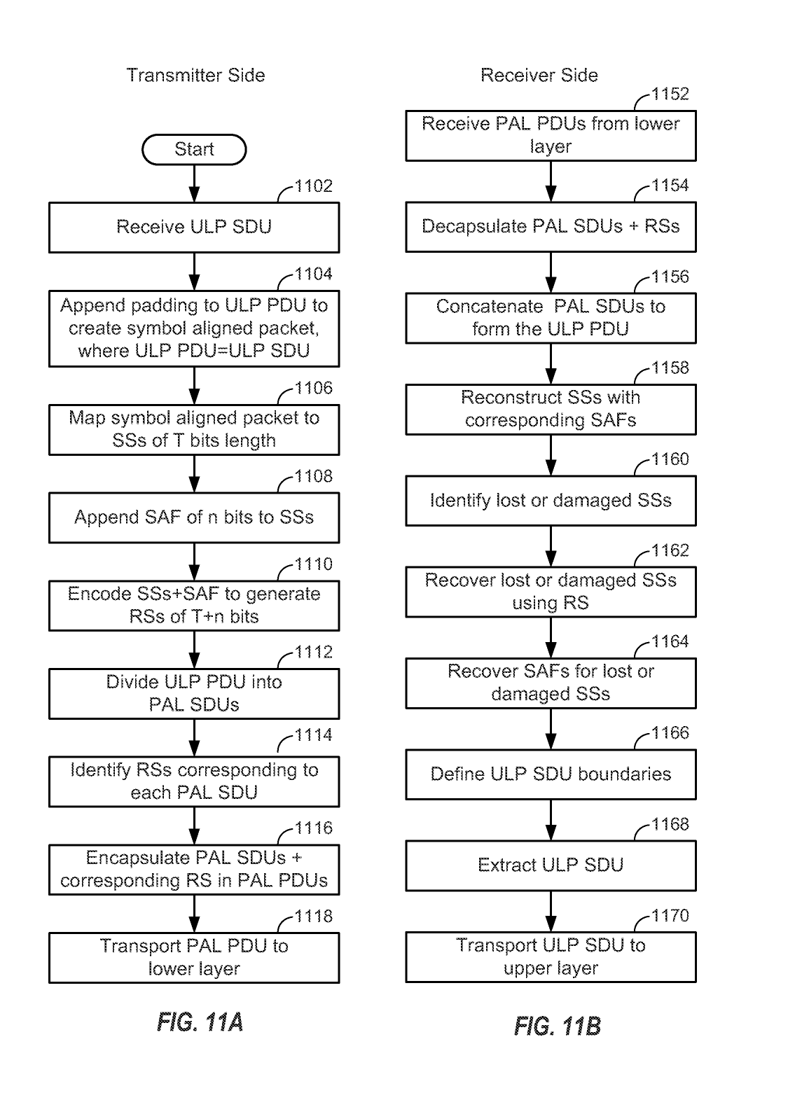

FIG. 11A is a flow diagram of framing a packet for transporting at a transmitter according to the alternative exemplary embodiment of FIG. 8B. In step 1102, the transmitter's PAL module receives a ULP SDU. In this embodiment, the ULP PDU is equal to the ULP SDU since no length field is added. Thus, there is a saving of two bytes per ULP SDU. Then, in step 1104, appropriate padding, in the form of octets, is added, to create symbol aligned packet. The length of the symbol aligned packet must be an integer multiple of T, which is the symbol length. In step 1106, the symbol aligned packet is mapped to source symbols. In step 1108, a Symbol Auxilliary Field of n bits is appended to each SS. For example n may be 8 or 16. This field comprises a one bit “Start” indicator and an n-1 bit “PadPlusOne” indicator. For each SS, the “Start” bit of the Symbol Auxiliary Field is set to one if and only if the source symbol contains the beginning of a ULP SDU. The “PadPlusOne” bit contains the number of padding octets at the end of the SS, or zero if the SS does not contain the end of a ULP SDU. In step 1110, the augmented SSs are encoded to generate RSs of T+n size according to chord elastic codes described earlier in this application. For the SS encoder, augmented SSs of T+n bits are used, where the n bits correspond to the SAF field. The resulting repair symbol(s) are each then considered as a T bit ordinary repair symbol plus an n bit Repair Symbol Auxiliary field. In step 1112, the ULP SDU is segmented into PAL SDUs. In step 1116, each PAL SDU is encapsulated with corresponding RSs in PAL PDUs. Corresponding RSs comprise RSs that protect the SSs that were included in the previous PAL SDU, as described earlier with reference to FIG. 8. Then, in step 1118, each PAL PDU is delivered to a lower layer.

FIG. 11B is a flow diagram of packet transporting at a receiver according to the exemplary embodiment of FIG. 8B. In step 1152, the receiver's PAL module receives the PAL PDUs. In step 1154, the PAL SDUs and the corresponding RSs are decapsulated. Then, in step 1156, the PAL SDUs are concatenated to form a provisional ULP SDU. In step 1158, the SSs are reconstructed with their corresponding SAFs. Then, in step 1160 the lost or damaged SSs are identified. Using the RSs, the lost or damaged SSs are recovered in step 1162. Then, the SAFs for the lost or damaged SSs are recovered, in step 1164. This helps identify the boundaries of the transmitted ULP SDU in step 1166. Next, in step 1168, the transmitted ULP SDU is extracted. Finally, in step 1170, the ULP SDU is delivered to the upper layer.

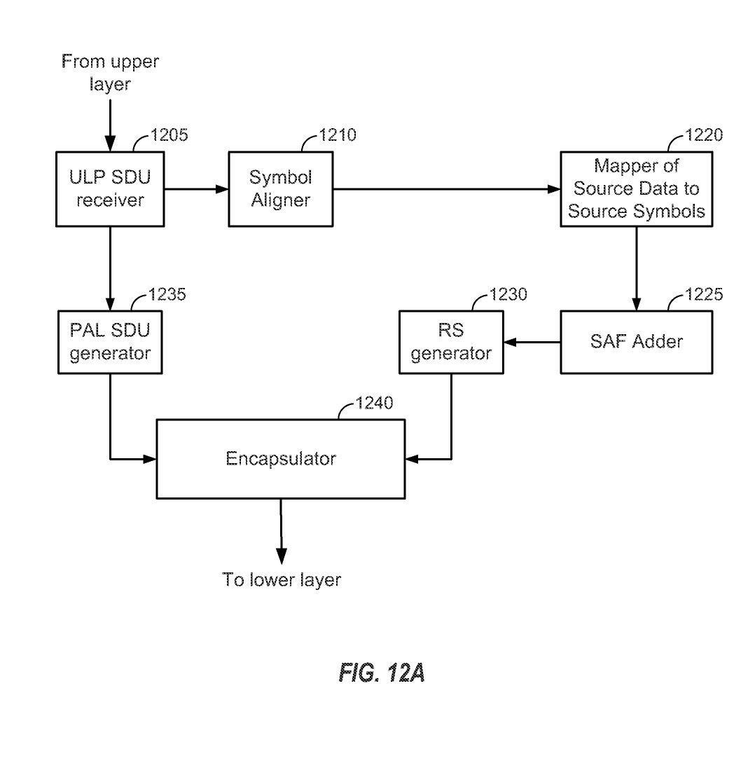

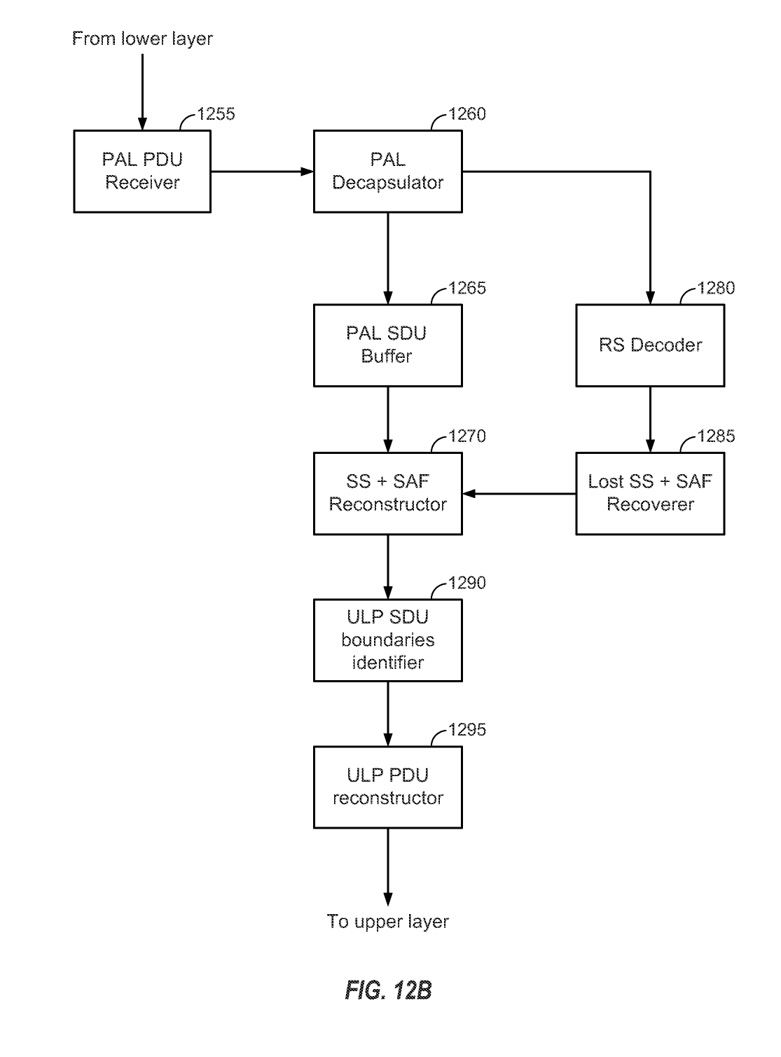

FIG. 12A is a block diagram of a transmitter PAL module according to the exemplary embodiment of FIG. 8B. Transmitter PAL module 1200 comprises ULP SDU receiver 1205 acting as an interface for receiving ULP SDUs from an upper layer. ULP SDU receiver 1205 forwards the ULP SDU to symbol aligner 1210 and to PAL SDU generator 1235. Symbol aligner 1210 adds appropriate padding to the ULP SDU to form a symbol aligned packet. The length of the symbol aligned packet, comprising ULP SDU and padding, must be a multiple of one symbol length. Then, symbol aligner 1210 forwards the symbol aligned packet to Mapper 1220 where the symbol aligned packet is mapped to source symbols of size T bits. An SAF adder 1225 augments the source symbols with a Symbol Auxilliary Field of size n bits. The SAF is used to indicate the boundaries of the ULP SDU. The new SSs of size T+n are fed to repair symbol generator 1230, where repair symbols of size T+n are generated based on chord elastic codes as described earlier. In parallel, PAL SDU generator 1235 receives ULP SDU (with no padding) and segments it to generate a plurality of PAL SDUs. In principle, the size of each PAL SDU must be such that only one PAL SDU is included in each physical layer packet. Each PAL SDU coming from PAL SDU generator 1235 and RS symbols coming from RS generator 1230 are fed to encapsulator 1240 where appropriate framing and flow headers are added as described with reference to FIG. 7. Encapsulator 1240 produces PAL PDUs that are subsequently delivered to lower layers for further framing and processing. It is noted that the RSs encapsulated with a PAL SDU protect, generally, source symbols that were encapsulated in the previous PAL PDU. However, if insufficient source data is available to fill a PAL PDU, and one or more repair symbols could be included in the same PAL PDU without reducing the amount of source data in that packet, then a repair symbol may be included in the same PAL PDU with the last source octet it protects. It is also noted that the RSs generated are of size T+n bits, where the T bits belong to an ordinary repair symbol and the n bits to a repair symbol auxiliary field (RSAF). The SAFs for the source symbols are not sent over the air. Instead, RSAFs are transmitted as part of the T+n bits RSs.

FIG. 12B is a block diagram of a receiver PAL module according to the exemplary embodiment of FIG. 8B. PAL PDU receiver 1255 receives a PAL PDU from a lower level. Then, decapsulator 1260 decapsulates a PAL SDU and any corresponding RSs included in the PAL PDU. Each PAL SDU is fed to PAL SDU buffer 1265 and the RSs to RS decoder 1280. PAL SDU buffer 1270 concatenates all PAL SDUs corresponding to a provisional ULP SDU and the concatenated PAL SDUs are fed to SS and SAF reconstructor 1270 to reconstruct the received SSs and corresponding SAFs. Decoder 1280 receives the reconstructed SSs and SAFs, as well as the decapsulated RSs, decodes the RSs and recovers any lost SSs and corresponding SAF information. Source symbols from decoder 1280 are delivered to SS and SAF reconstructor 1270 to complete the reconstruction. The reconstructed or recovered SSs are fed to ULP SDU boundaries identifier where, using SAF information, the boundaries of the recovered ULP SDUs are identified. Then, ULP SDU extractor 1295 extracts the ULP SDU that is subsequently delivered to upper layers.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method (400) of scheduling the transmission of a set of repair symbols along with a stream of source symbols, comprising:
generating (415) a first repair symbol by encoding a first set of source symbols of number B; and
generating (43) a second repair symbol by encoding an overlapping set of source symbols of number B, wherein the overlapping set is a combination of a first subsequent set of source symbols of number A with (B-A) number of source symbols at the end of the first set of source symbols, whereby A and B are selected so as to minimize source symbol retransmission to a receiver.

2. The method of claim 1, further comprising:
identifying (410) a subsequent set of source symbols of number A;
combining (425) the A source symbols with (B-A) number of symbols preceding the subsequent set of source symbols to create an overlapping set of source symbols of number B; and
generating (430) a subsequent repair symbol by encoding the overlapping set of symbols of number B.

3. The method of claim 2, further comprising:
repeating the steps of identifying, combining and generating a subsequent repair symbol for all source symbols in the stream.

4. The method of claim 1, wherein B is associated with the latency the receiver is willing to introduce in the stream of source symbols.

5. The method of claim 1 where A is associated with the loss rate of transmission.

6. A method of reconstructing a stream of source symbols received from a transmitter, comprising:
identifying (440) a first set of source symbols belonging to the stream of source symbols;
identifying (440) at least one symbol in the first set of symbols that was lost or received damaged;
identifying (450) at least a first repair symbol received from the transmitter protecting at least a portion of the first set of source symbols, wherein the at least one symbol belongs to the portion; and
decoding (455) the at least first repair symbol to recover the at least one lost or damaged SS, when the at least one lost or damaged SS belongs to the portion of the first set of symbols.

7. A repair symbol generator (663) for encoding source symbols comprising:
an RS scheduler (664) to identify overlapping sets of B number of SSs in a stream of SSs for providing scheduling information to an SS encoder for the generation of RS symbols; and
an SS encoder (666) to generate RSs in response to scheduling information provided by the RS scheduler.

8. The RS generator of claim 7, where the RS scheduler identifies a new overlapping set every time an A number of SSs in the stream of SSs has been transmitted.

9. The RS generator of claim 8, where the SS encoder generates RSs from an overlapping set of SSs, where the overlapping set comprises the A number of SSs from the second set of SSs and the last part of (B-A) number of SSs of the first set of SSs.

10. A method (600A) of scheduling the transmission of a set of repair symbols along with a stream of source symbols, comprising:
identifying (614) a message from the receiver acknowledging receipt of a number of SSs from a first set of SSs encoded to generate a first repair symbol; and
generating (622) a second repair symbol by encoding an overlapping set of source symbols, where the overlapping set is a combination of a subsequent set of source symbols of number A with an N number of source symbols from the first set that have yet to be acknowledged from the receiver.

11. The method of claim 10 further comprising:
identifying (610) the first set of source symbols in the stream of source symbols;
generating (612) the first repair symbol by encoding the first set of source symbols;
identifying (616) the N number of SSs from the first set that have yet to be acknowledged from the receiver;
identifying (618) the subsequent set of source symbols of number A in the same stream of source symbols; and
combining (620) the A source symbols with the N source symbols to create the overlapping set of source symbols.

12. A method, in a receiver, of reconstructing a stream of source symbols received from a transmitter, comprising:
identifying a subset of a first set of source symbols received correctly or recovered by decoding a set of repair symbols; and
sending a receipt acknowledgment message to the transmitter for the subset of the first set of symbols, to control the scheduling of a subsequent repair symbol.

13. The method of claim 12 further comprising:
identifying a first set of source symbols belonging to the stream of source symbols;
identifying a first part of the subset received correctly;
identifying a second part of the subset received incorrectly;
identifying a set of repair symbols protecting the source symbols in the second part; and
decoding the set of repair symbols to recover at least one of the source symbols belonging to the second subset.

14. An RS generator (663) for scheduling the transmission of RSs comprising:
an RS scheduler (664) to identify the beginning of a first set of SSs in a stream of SSs by detecting a message received from a receiver acknowledging receipt of a number of SS, to provide scheduling information to an SS encoder for the generation of RS symbols; and
an SS encoder (666) to generate RSs in response to scheduling information provided by the RS scheduler.

15. A method of scheduling the transmission of a set of repair symbols along with a stream of source symbols, comprising:
identifying (636) a message from the receiver non-acknowledging receipt of a particular SS from a first set of SSs encoded to generate a first repair symbol; and
generating (642) a second repair symbol by encoding an overlapping set of source symbols, where the overlapping set is a combination of a subsequent set of source symbols of number M identified at the time the message was received with an N number of source symbols from the first set including at least the particular non-acknowledged SS.

16. The method of claim 15 further comprising:
identifying (630) the first set of source symbols in the stream of source symbols;
generating (632) the first repair symbol by encoding the first set of source symbols;
identifying (634) the subsequent set of source symbols of number M in the same stream of source symbols;
identifying (638) the N number of SSs from the first set that have yet to be acknowledged from the receiver; and
combining (640) the M SSs with the N SSs to create the overlapping set of source symbols.

17. A method of reconstructing a stream of source symbols received from a transmitter, comprising:
identifying a source symbol belonging to a first set of symbols lost or received incorrectly after a first subset of the first set of symbols was received correctly or was reconstructed with repair symbols protecting the source symbols belonging to the first subset; and
sending a non-acknowledgement message to the transmitter, to request transmission of an extra repair symbol protecting at least the source symbol received incorrectly.

18. The method of claim 17 further comprising:
identifying the first set of source symbols belonging to the stream of source symbols;
identifying the first subset of the first set of symbols received correctly;
identifying at least one extra repair symbol; and
decoding a set of repair symbols including the at least one identified extra repair symbol to recover at least the source symbol received incorrectly.

19. An RS generator (663) for scheduling and generating RSs comprising:
an RS scheduler to identify the beginning and the end of a first set of SSs in a stream of SSs by detecting a message received from a receiver, non-acknowledging receipt of a particular SS, to provide scheduling information to an SS encoder for the generation of an RS; and
an SS encoder (666) to generate an RS in response to scheduling information provided by the RS scheduler.

20. A repair symbol generator for encoding source symbols comprising:
means for identifying overlapping sets of B number of SSs in a stream of SSs for providing scheduling information to a means for generating RSs; and
means for generating RSs in response to scheduling information provided by the means for identifying.

21. The RS generator of claim 7, where the means for identifying identify a new overlapping set every time an A number of SSs in the stream of SSs has been transmitted.

22. The RS generator of claim 8, where the means for generating generate RSs from an overlapping set of SSs, where the overlapping set comprises the A number of SSs from the second set of SSs and the last part of (B-A) number of SSs of the first set of SSs.

23. An RS generator for scheduling the transmission of RSs comprising:
means for identifying the beginning of a first set of SSs in a stream of SSs by detecting from a receiver a message acknowledging receipt of a number of SS, to provide scheduling information to means for generating of RS symbols; and
means for generating RSs in response to scheduling information provided by the means for identifying.

24. A generator for scheduling and generating RSs comprising:
means for identifying the beginning and the end of a first set of SSs in a stream of SSs by detecting from a receiver a message non-acknowledging receipt of a particular SS, to provide scheduling information to means for generating RSs; and
means for generating RSs in response to scheduling information provided by the RS scheduler.

25. A computer program product for use with a processor device that schedules the transmission of a set of repair symbols along with a stream of source symbols, the computer program product having instructions to cause the processor device to:
generate a first repair symbol by encoding a first set of source symbols of number B; and
generate a second repair symbol by encoding an overlapping set of source symbols of number B, wherein the overlapping set is a combination of a first subsequent set of source symbols of number A with (B-A) number of source symbols at the end of the first set of source symbols, whereby A and B are selected so as to minimize source symbol retransmission to a receiver.

26. A computer program product for use with a processor device that reconstructs a stream of source symbols received from a transmitter, the computer program product having instructions to cause the processor device to:
identify a first set of source symbols belonging to the stream of source symbols;
identify at least one symbol in the first set of symbols that was lost or received damaged;
identify at least a first repair symbol received from the transmitter protecting at least a portion of the first set of source symbols, wherein the at least one symbol belongs to the portion; and
decode the at least first repair symbol to recover the at least one lost or damaged SS, when the at least one lost or damaged SS belongs to the portion of the first set of symbols.

27. A computer program product for use with a processor device that schedules the transmission of a set of repair symbols along with a stream of source symbols, the computer program product having instructions to cause the processor device to:
identify a message from the receiver acknowledging receipt of a number of SSs from a first set of SSs encoded to generate a first repair symbol; and
generate a second repair symbol by encoding an overlapping set of source symbols, where the overlapping set is a combination of a subsequent set of source symbols of number A with an N number of source symbols from the first set that have yet to be acknowledged from the receiver.

28. A computer program product for use with a processor device that reconstructs a stream of source symbols received from a transmitter, the computer program product having instructions to cause the processor device to:
identify a subset of a first set of source symbols received correctly or recovered by decoding a set of repair symbols; and
send a receipt acknowledgment message to the transmitter for the subset of the first set of symbols, to control the scheduling of a subsequent repair symbol.

29. A computer program product for use with a processor device that schedules the transmission of a set of repair symbols along with a stream of source symbols, the computer program product having instructions to cause the processor device to:
identify a message from the receiver non-acknowledging receipt of a particular SS from a first set of SSs encoded to generate a first repair symbol; and
generate a second repair symbol by encoding an overlapping set of source symbols, where the overlapping set is a combination of a subsequent set of source symbols of number M identified at the time the message was received with an N number of source symbols from the first set including at least the particular non-acknowledged SS.

30. A computer program product for use with a processor device that reconstructs a stream of source symbols received from a transmitter, the computer program product having instructions to cause the processor device to:
identify a source symbol belonging to a first set of symbols lost or received incorrectly after a first subset of the first set of symbols was received correctly or was reconstructed with repair symbols protecting the source symbols belonging to the first subset; and
send a non-acknowledgement message to the transmitter, to request transmission of an extra repair symbol protecting at least the source symbol received incorrectly.
